(19) United States
(12) Patent Application Publication
(10) Pub. No.: US 2010/0276026 A1
(43) Pub. Date: Nov. 4, 2010

(54) HOSE-IN-HOSE TERMINATION FITTING

(75) Inventors: Steven M. Powell, Chardon, OH (US); Michael A. Sweeney, Kent, OH (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(73) Assignee: Parker-Hannifin Corporation, Cleveland, OH (US)

(21) Appl. No.: 12/705,024

(22) Filed: Feb. 12, 2010

Related U.S. Application Data
(60) Provisional application No. 61/175,179, filed on May 4, 2009.

(51) Int. Cl. F16L 55/10; B23P 11/00

(52) U.S. Cl. 138/114; 29/428

(57) ABSTRACT

A coaxial hose fitting includes an inner body including an outer end portion configured for connection to an external component, an inner end portion configured for connection to an inner conduit of a coaxial hose, and an axially extending passage through the inner body from the outer end portion to the inner end portion. An outer housing including an inner end portion configured for connection to an outer conduit of the coaxial hose and an axially extending hole through the outer housing from the inner end portion of the outer housing to an outer end portion of the outer housing, the hole being sized such that the outer housing can be telescopically moved over the inner body from the outer end portion of the inner body toward the inner end portion of the inner body. A retaining element restricts axial movement of the outer housing relative to the inner body after the outer housing has been telescopically moved over the inner body.

### RELATED APPLICATIONS

This application claims the benefit of U.S. Provisional Application No. 61/175,179 filed May 4, 2009, the entirety of which is hereby incorporated herein by reference.

### FIELD OF INVENTION

The present invention relates generally to the field of hose fittings and hose fitting assemblies, and more particularly to fittings for hose-in-hose assemblies.

### BACKGROUND

A hose-in-hose assembly (also referred to as “coaxial hose”) typically is assembled by inserting one hose inside of another hose. Coaxial hoses commonly are used to transport two fluids independently of one another through a common or shared fitting. Coaxial hoses are especially useful in fluid systems in which space is limited or in which the fluid in one hose is used to heat or to cool the fluid in the other hose.

Coaxial hose fittings can be difficult or complicated to assemble and/or repair without damaging the fitting and/or the coaxial hose. Coaxial hose fittings also can be difficult to install on a coaxial hose due to the natural tendency of hoses to coil and/or kink and the need to form a connection with the inner hose and outer hose separately of one another.

### SUMMARY OF INVENTION

The present invention provides a novel fitting that enables an inner nipple to be connected to an inner hose of a coaxial hose assembly and an outer housing to be telescoped over an outer end of the nipple and then moved into position for connection to an outer hose of the coaxial hose assembly.

According to one aspect of the invention, a termination fitting for a coaxial hose assembly includes an inner fluid conduit for a first fluid received coaxially in an outer fluid conduit for a second fluid, each of the inner and the outer fluid conduits terminating at a distal end disposable generally coterminous with the distal end of the other fluid conduit. The fitting includes a body extending along a longitudinal body axis intermediate a body first end and a body second end. The body has a first passageway therethrough for a first fluid. The first passageway extends along the body axis intermediate a first opening at the body first end and a second opening at the body second end. The body first end is configured as an inner connector for a distal end of an inner fluid conduit. The fitting also has a housing extending along a longitudinal housing axis intermediate a housing first end and a housing second end, the housing being received coaxially over the body and having a second passageway therethrough for the second fluid. The second passageway extends along the housing axis intermediate a first opening at the housing first end and a second opening at the housing second end. The housing has a third opening into the second passageway between the housing first and second ends, and the housing first end is configured as an outer connector for a distal end of an outer fluid conduit.

A seal is disposed between the housing and the body intermediate the housing second and third openings. The seal closes the housing second opening such that the second fluid flows through the second passageway between the housing first and third openings.

According to another aspect of the invention, a coaxial hose fitting includes an inner body including an outer end portion configured for connection to an external component, an inner end portion configured for connection to an inner conduit of a coaxial hose, and an axially extending passage through the inner body from the outer end portion to the inner end portion. The coaxial fitting has an outer housing including an inner end portion configured for connection to an outer conduit of the coaxial hose and an axially extending hole through the outer housing from the inner end portion of the outer housing to an outer end portion of the outer housing, the hole being sized such that the outer housing can be telescopically moved over the inner body from the outer end portion of the inner body toward the inner end portion of the inner body. A retaining element restricts axial movement of the outer housing relative to the inner body after the outer housing has been telescopically moved over the inner body.

According to another aspect of the invention, a method of assembling a fitting to a coaxial hose assembly includes attaching an inner body to an inner hose, the inner body having a through passage for communicating with an interior portion of the inner hose, telescopically moving an outer housing over the inner body from an outer end portion of the body towards an inner end portion of the body, positioning an axially inner end portion of the outer body coextensively with an outer hose which, together with the inner hose, forms a coaxial hose; and restricting axial movement of the outer housing relative to the inner body.

In an embodiment, removal and/or servicing of the fitting and coaxial hose assembly can be effected without damaging or destroying the fitting. For instance, the outer housing can be secured to the outer hose by a removable clamp, whereby the clamp can be removed and the outer hose can be readily disassembled with respect to the nipple, and the fitting and/or coaxial hose can be serviced or removed without damaging or destroying the fitting or the coaxial hose.

In an embodiment, rotational movement of the outer housing relative to the inner body may allow the fitting to be easily manipulated during installation, enable easier alignment of side ports or openings in the outer housing with other components of the fluid system, and allow relaxation of twists in the outer hose.

In an embodiment of the coaxial hose fitting, the retaining element may be a threaded engagement between the inner body and the outer housing.

In another embodiment the retaining element is a clip ring positioned to capture the outer housing on the inner body. Preferably, the clip ring is easily removable for disassembling and/or repair.

The foregoing and other features of the invention are hereinafter described in greater detail with reference to the accompanying drawings.

### BRIEF DESCRIPTION OF THE DRAWINGS

FIG. 1 is an isometric view of an exemplary embodiment of a coaxial hose fitting in accordance with the invention.

FIG. 2 is a side elevation view of the exemplary coaxial hose fitting of FIG. 1 partially cut away in cross-section.

FIG. 3 is an enlarged portion of FIG. 2.

FIG. 4 is a side elevation view showing the coaxial hose fitting of FIG. 1 installed to a coaxial hose.

FIG. 5 is a cross-sectional view of the coaxial hose fitting assembly of FIG. 4.

FIG. 6 is a cross-sectional view of another exemplary embodiment of a coaxial hose fitting.

FIGS. 7A-7H illustrate an exemplary method of assembling the coaxial hose fitting assembly of FIG. 4.

### DETAILED DESCRIPTION

Although applicable to a wide variety of systems, the principles of the present invention have particular application to fluid systems that utilize a flexible coaxial hose for maintaining separation of two fluids during transport to a common fitting.

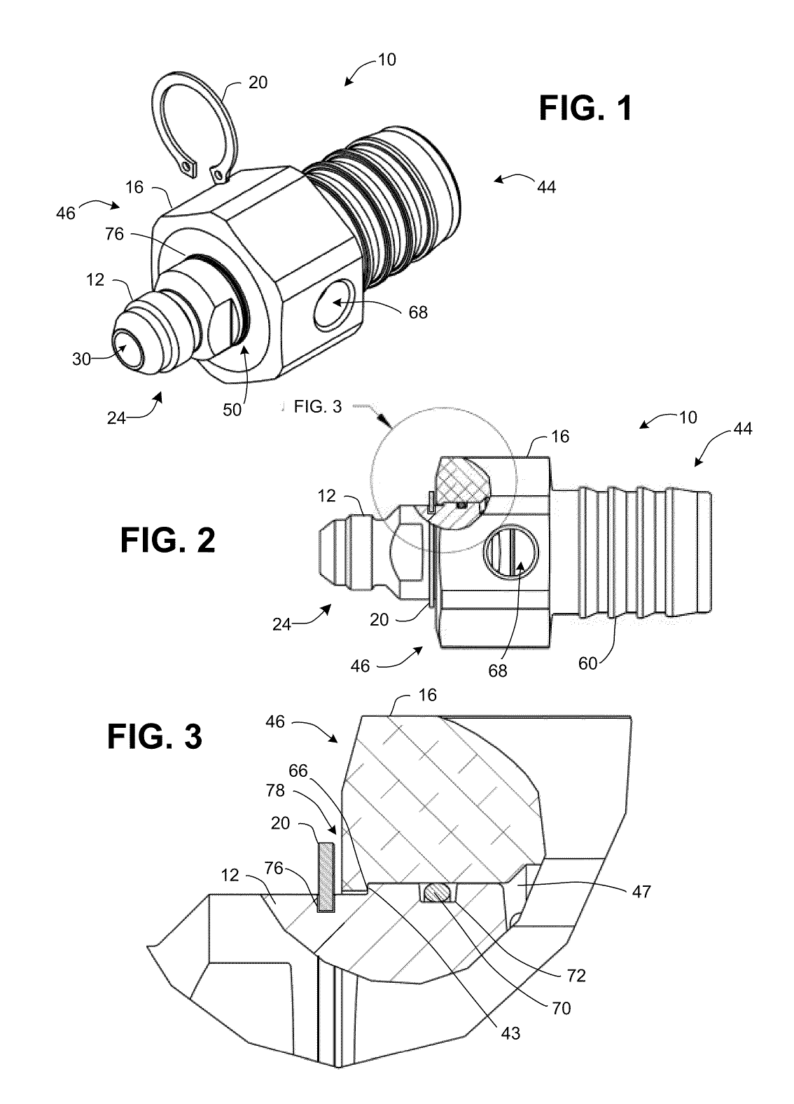

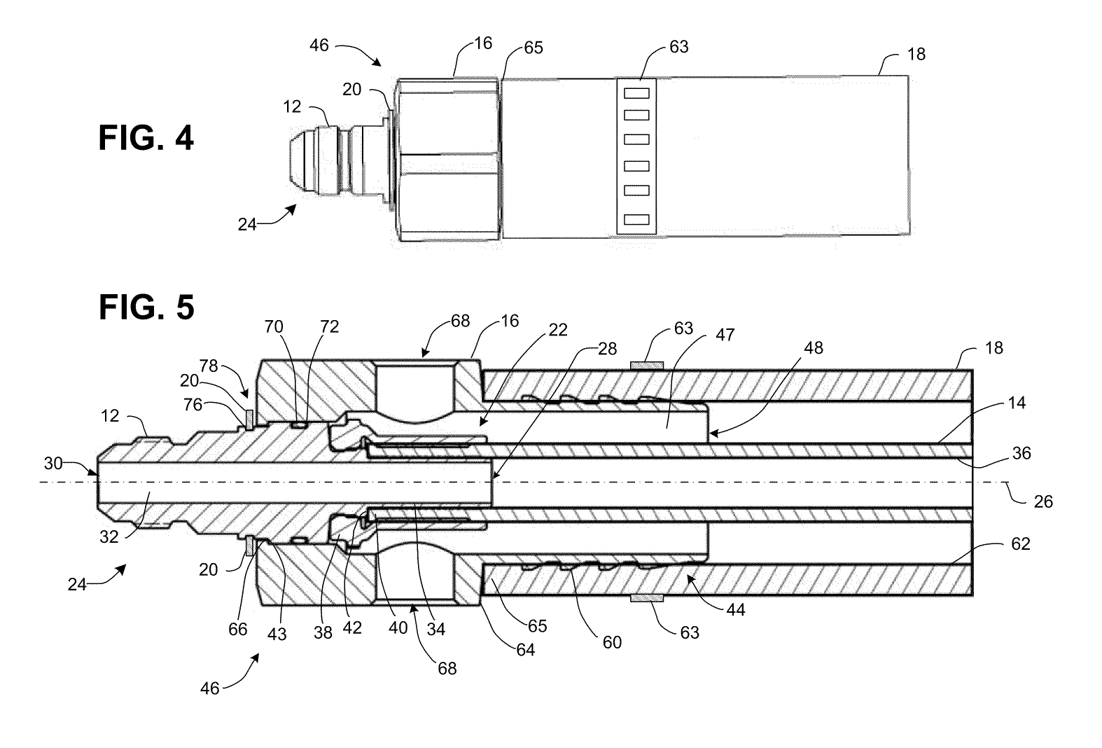

Referring initially to FIGS. 1-5, an exemplary hose-in-hose termination fitting 10 (also referred to as a “coaxial hose fitting” or a “termination fitting”) for a coaxial hose is shown. The fitting 10 includes an inner body 12 (also referred to as a “body” or “nipple”) configured for connection to an inner conduit 14 of the coaxial hose, an outer housing 16 (also referred to as a “housing”) configured for connection to an outer conduit 18 of the coaxial hose. A retaining element 20 restricts axial movement of the outer housing 16 relative to the inner body 12.

The inner body 12 is an elongate member having a first end portion 22 (also referred to as an “inner end”), which is configured for connection to the inner conduit 14. The body 12 also includes a second body portion 24 (also referred to as an “outer end”) configured for connection to another component of a fluid system. The body 12 has a generally tubular shape that extends along a longitudinal axis 26 intermediate the inner end portion 22 and the outer end portion 24.

At the inner end portion 22 is a first body opening 28 and at the outer end portion 24 is a second body opening 30. The body openings 28, 30 are connected to one another by a passageway 32 that extends through the body 12. Although the body 12 and the passageway 32 in the illustrated embodiment are shown as extending along the longitudinal axis 26, the body and passageway may have a different shape, as may be necessary or desired for different applications. For example, the body and passageway may incorporate one or more curves, such as an elbow or other shape, for example.

The openings 28, 30 at the end portions of the body 12 are in fluid communication with one another such that when the inner end portion 22 of the body 12 is connected to the inner conduit 14 of the coaxial hose, fluid from the inner conduit 14 passes through the first body opening 28 and the passageway 32 to the second body opening 30 and then to the external component connected to the outer end portion 24.

The outer end portion 24 is configured for connection to an external component or work member of a fluid system. For example, the connection can be accomplished by an assortment of machined-on connections (e.g., SAE J516 (R) hydraulic hose fittings) or adapters (e.g., SAE J513 refrigeration tube fittings or SAE J512 automotive tube fittings). The connection can be any conventional fluid connector, such as a standard SAE or ISO port connector, or another connector.

As mentioned above, the inner end portion 22 of the inner body 12 is configured for connection to the inner conduit 14. The inner end portion 22 therefore includes one or more components for effecting connection of the body 12 to the inner conduit 14. As shown in the exemplary embodiment of FIG. 5 in which the inner body 12 is a nipple, the inner end portion 22 includes a number of barbs or ridges 34 for engaging the inner wall 36 of the conduit 14. Although the barbs 34 may be sufficiently strong to hold the inner conduit 14 on the inner body 12 for low pressure applications, the inner end portion 22 may also include a crimp sleeve 38 for higher pressure applications.

The crimp sleeve 28 may be connected to the inner body 12 by a threaded connection. The connection can define a space between the crimp sleeve 38 and the barbs into which the inner conduit 14 can be received. The inner conduit 14 can be wedged into the space until the distal end 40 of the inner conduit 14 abuts a shoulder 42. Additionally, although not shown in the exemplary embodiment of FIGS. 1-5, the connection between the crimp sleeve 38 and the inner body 12 can be sealed with an elastomeric sealing member, for example an O-ring disposed within the space between the inner body 12 and the crimp sleeve 38.

It should be appreciated that the nipple 12 and crimp sleeve 38 arrangement is only one exemplary arrangement of the inner body 12. Other arrangements also may be possible, including, for example, integrating the nipple 12 and the crimp sleeve 38 into a single, unitary structure, incorporating additional components into the body, and/or providing different connectors on the end of the nipple for connection to any of a variety of different components in the fluid system, etc.

A portion of the inner body 12 intermediate of the inner end portion 22 and the outer end portion 24 includes an abutment 43. As described in more detail below, the abutment 43 acts as a positive stop to limit the axial movement of the outer housing 14 relative to the inner body 12 when the housing 16 is installed on the inner body 12. In the embodiment of FIGS. 1-5, the abutment is an annular shoulder having a radially outwardly extending surface that faces in the direction of the outer end portion 24 of the body 12.

Continuing to refer to FIGS. 1-5, in the illustrated embodiment, the housing 16 is an elongate member having a first end portion 44 (also referred to as an “housing inner end portion”) and a second housing end portion 46 (also referred to as an “housing outer end portion”). The housing 16 has a generally tubular shape that extends along the longitudinal axis 26 intermediate of the housing inner end portion 44 and the housing outer end portion 46.

The end portions 44, 46 of the housing 16 are connected to one another by a hole 47 extending along the longitudinal axis 26 through the housing from a first housing opening 48 on the housing inner end portion 44 to a second housing opening 50 on the housing outer end portion 46.

The housing inner end portion 44 is configured for connection to the outer conduit 18. The housing inner end portion 44 can include one or more components for effecting connection to the outer conduit 18. For example, the housing inner end portion 44 can include a plurality of annular ridges or barbs 60 that are configured to engage the inner diameter 62 of the outer conduit 18, as is conventional. Although the barbs 60 may be sufficiently strong to hold the outer conduit 18 on the outer housing 16 for low pressure applications, a securing mechanism 63, such as a screw clamp, band, or other mechanism, can be attached to the exterior of the outer conduit 18 for higher pressure applications.

The housing inner end portion 44 also includes an annular shoulder 64 that acts as a stop for a distal end 65 of the outer conduit 18 when the fitting 10 is assembled and connected to the coaxial hose.

On the opposite end of the outer housing 16 (e.g., the housing outer end portion 46), the second housing opening 50 can allow at least part of the outer end portion 24 of the body 12 to pass through the opening 50 when the housing 16 is telescopically moved over the inner body 12 to receive the inner body 12 in the hole 47.

The hole 47 may be an axially extending hole, preferably having a circular cross-section that is sized for telescopic receipt of the inner body 12. The hole 47 is sized such that the housing can be telescoped over the inner body 12 from the outer end portion 24 of the inner body 12 towards the inner end portion 22 of the body 12. After the outer housing 16 is telescoped over the inner body 12, axial movement of the outer housing 16 is restricted by the retaining element 20 such that the outer housing 16 cannot be removed from the body 12 by sliding the housing 16 in the opposite direction (e.g., towards the outer end portion 24 of the inner body 12).

The hole 47 can include an abutment 66 for limiting the axial movement of the outer housing 12 relative to the inner body 12. As shown in the embodiment of FIGS. 1-5, the abutment 66 may be a radially inwardly abutment, such as an annular shoulder with a surface that faces the inner housing end portion 44, and the diameter of the hole 47 at the housing inner end portion 44 may be greater than the diameter of the hole 47 at the housing outer end portion 46.

The abutment 66 on the outer housing 16 may contact or engage the abutment 43 on the inner body 12 when the outer housing 16 is installed over the outer hose end portion 46 towards the inner hose end portion 44. The abutting surfaces can limit the telescopic movement of the inner body 12 relative to the outer housing 16 in the axial direction. For example in the illustrated embodiment, only a portion of the inner body 12 (e.g., the outer end portion 24 including the connector for the external component and the annular groove 64 for receiving the retaining element 20) passes through the second housing opening 78 when the housing 16 in installed on the body 12.

The abutments 43, 66 can be any of a number of different configurations. In the illustrated embodiment, the shapes of the abutments are complementary to one another, with the abutment 43 on the inner body 12 having a surface facing the outer end portion 24 of the inner body 12 and the abutment 66 on the outer housing 16 having a surface that faces the inner end portion 22 of the inner body 12 when the fitting is assembled. Although the abutments 43, 66 are shown as annular shoulders, it should be appreciated that they could be another shape and may not be complementary shapes to one another.

The intermediate portion of the housing 16 also can have additional openings for connection to other components of the fluid system. For example, the embodiment of FIGS. 1-5 has two additional housing openings 68 between the first housing opening 48 and the second housing opening 50. The additional openings 68 are in fluid communication with the first housing opening 48 through the hole 47. The additional housing openings 68 are configured for connection to respective hoses or other fittings, for example to provide a pathway to recirculate the fluid in the outer conduit 18. The additional housing openings 68 are perpendicular or transverse to the first and second housing openings 48, 50, such that the fitting 10 is in the form a cross. It will be appreciated that the housing 16 may only have one additional housing opening and therefore may be shaped as a “T,” “Y”, or another shape.

The intermediate portion of the outer housing also may include one or more sealing elements that close the housing second opening 50 such that the fluid from the outer conduit 18 flows through the hole 47 between the opening 48 on the housing inner end portion 44 and the one or more additional openings 68 first and third openings. The sealing elements may be an elastomeric element (e.g., O-ring), a ferrous/non-ferrous ring, and/or metal-to-metal contact abutments 43, 66. In the illustrated embodiment of FIGS. 1-5, the seal is provided by an O-ring 70 disposed in an annular channel 72 on the inner body 12 located between the abutment 43 and inner end portion 22 and metal-to-metal contact between the abutment surfaces 43, 66. The sealing element(s) may be located at a different location, for example, a sealing element may be located at or near the abutments on the inner and housings, such as between the sleeve 38 and the hole 47 through the housing 16. A sealing element 70 also could be disposed in a channel on the outer housing 16, or at another location.

The elastomeric sealing element 70 on the body 12 contacts the hole 47 to seal the connection between the body 12 and the housing 16 and seals the abutment between the body 12 and the housing 16. Fluid entering the housing 16 from the outer conduit 18 is therefore blocked from passing through the second housing opening 72 and instead is directed through the additional housing opening 68 where it can be recirculated or directed to another portion of the fluid system.

Axial movement of the outer housing 16 relative to the inner body 12 is limited by the retaining member 20. In the embodiment of FIGS. 1-5, the retaining element 20 surrounds at least a portion of the outer end portion 22 of the body 12 to trap the outer housing 16 between the retaining member 20 and the abutment 43 on the inner body 12, thereby limiting the axial movement of the outer housing 16 relative to the inner body 12. In FIGS. 1-5, the retaining member traps the abutment 66 on the outer housing 16 between the retaining member 20 and the abutment 43 on the inner body 12.

The retaining member 20 can be an annular ring that is removably received in an annular groove 76 in the outer end portion 24 of the body 12. The annular groove 76 can be located between the outer end portion 24 of the body 12 and the outer end portion 46 of the outer housing 16. In the illustrated embodiment, the annular ring is snap ring, “C” ring, or other annular member that surrounds at least a portion of the body 12 to restrict or limit the axial movement of the housing 16 relative to the body 12.

As shown best in FIG. 3, there may be a space 78 between the retaining element 20 and the second housing end 66. The space 78 allows for a limited amount of axial movement between the inner body 12 and the outer housing 16. The limited amount of axial movement can allow the fitting 10 to accommodate small amounts of elongation and contraction of the coaxial hose, for example, as may occur as a result of heating and cooling of the hoses, pressure in the hoses, or other factors.

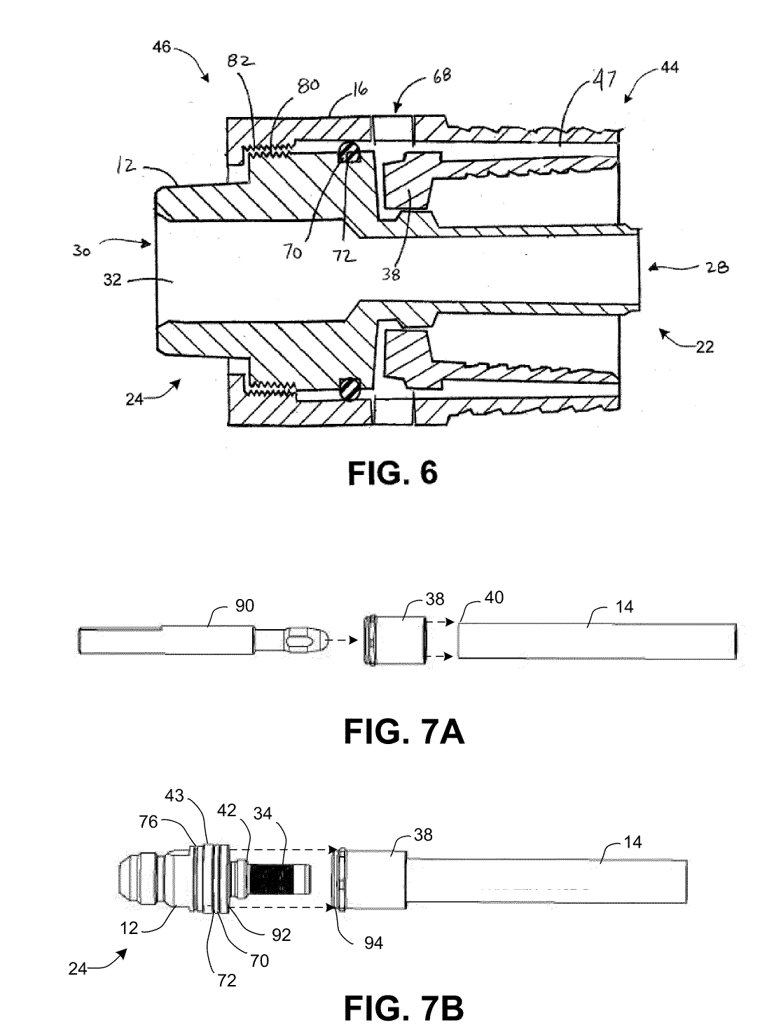

Referring to FIG. 6, another embodiment of a coaxial hose fitting 10 is shown. In the embodiment of FIG. 6, the retaining element 20 is a connection between the inner body 12 and the outer housing 16. The connection may be formed by threads, with the inner body having a threaded portion 80 that is engaged to a correspondingly threaded portion 82 of the outer housing 16. The threads can limit axial movement of the outer housing 16 relative to the inner body 12 when the outer housing 16 is installed on the inner body 12.

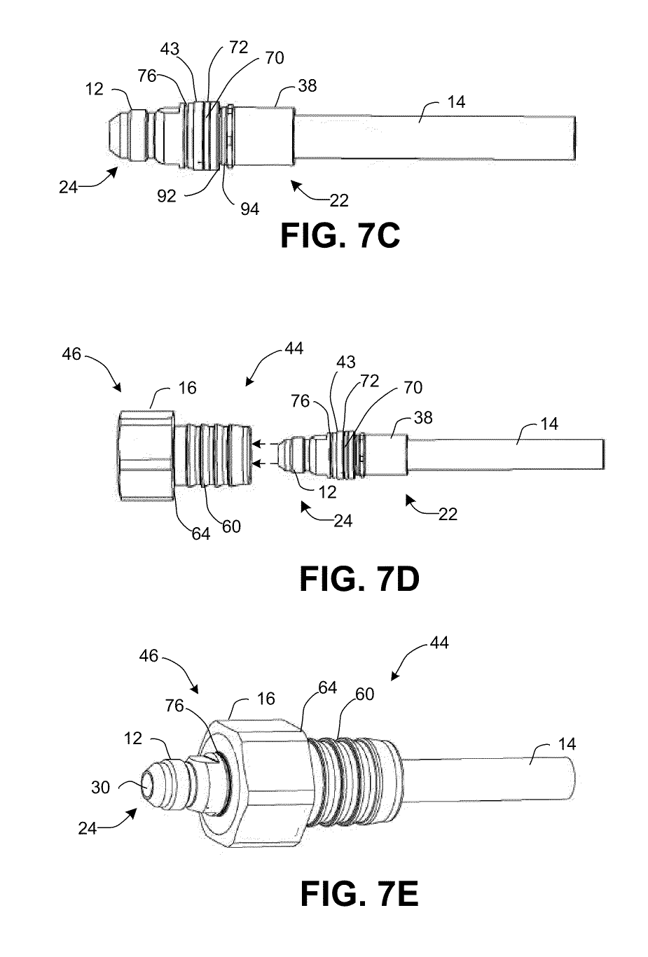

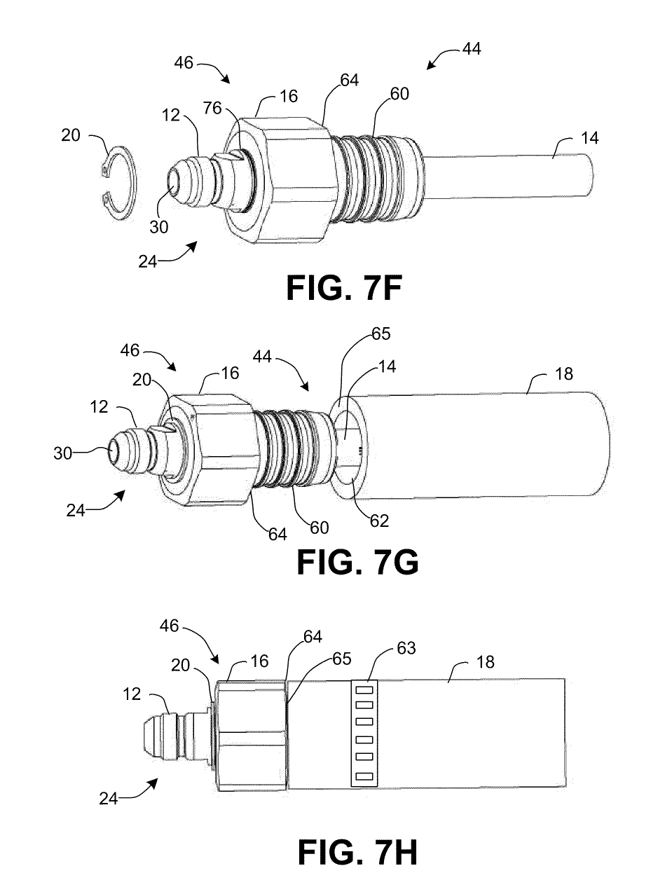

Referring now to FIGS. 7A-7H, a method of assembling the fitting of FIGS. 1-5 to a coaxial hose is shown. For purposes of brevity, the assembly of the fitting on one end of the coaxial hose is illustrated. It will be appreciated that a second fitting on the opposite end of the coaxial hose can be assembled and connected in the same manner.

In FIG. 7A, the inner conduit 14 for the coaxial hose is cut to a desired length and the distal end 40 of the inner conduit 14 is connected to the crimp sleeve 38. An expander tool 90 can be used to expand the inner diameter of the inner conduit 14 to facilitate connecting the crimp sleeve 38 to the inner conduit 14.

As shown in FIGS. 7B and 7C, the inner body 12 is connected to the inner conduit in a conventional manner. For example, in the exemplary embodiment of FIGS. 7A-7C, the inner end portion 22 of the inner body 12 is inserted into the distal end 44 of the inner conduit 14 and connected to the crimp sleeve 38. The inner end portion 22 may be threaded to engage a correspondingly threaded inner portion of the crimp sleeve 38. The inner body 12 and the crimp sleeve 38 are mated together until a shoulder 92 on the inner body 12 abuts a corresponding shoulder 94 on the crimp sleeve 38. FIG. 7C illustrates the inner body 12 and the crimp sleeve 16 in the fully assembled position and connected to the inner conduit 14.

As mentioned above, the inner body 12, including the inner end portion 22 connected to the crimp sleeve 38, is an example of one configuration for connecting the inner body 12 to the inner conduit 14. Other configurations also are possible, for example, the sleeve can be molded or formed as a unitary piece or the sleeve can be formed or molded onto the end of the inner conduit, etc.

Referring to FIG. 7D, the inner body 12 is received coaxially or telescopically by the hole 47 in the outer housing 16. The outer housing 16 is moved telescopically over the inner body 12 from the outer end portion 24 of the inner body 12 towards the inner end portion 22 of the inner body 12. To facilitate the insertion of the inner body 12 into the outer housing 16, the sealing member 70, for example, the sealing member can be lubricated with water, petroleum jelly, and/or another suitable substance.

The inner body 12 is inserted into the hole 47 in the outer housing 16 until the annular groove 64 for the restraining element 20 passes through the second housing opening 66 and/or the abutment 43 of the inner body 12 contacts the abutment 66 of the housing 16, as shown in FIG. 6E.

As shown in FIG. 7F, the retaining element 20 is slid onto the second body end portion 24. The retaining element 20 is retained by the annular groove 76 in the body 12. The retaining element 20 traps the abutment 66 of the outer housing 16 between the retaining element 20 and the abutment 43 on the inner body 12. The retaining element 20 also allows the outer housing 16 to rotate relative to inner the body 12 while limiting axial movement between the inner body 12 and the outer housing 16.

The rotational movement facilitates the assembly of the fitting by making the insertion of the inner body 12 within the outer housing 16 easier. Additionally, the rotational movement facilitates the alignment of the various openings in the inner body 12 and the outer housing 16 with the various other connections or components of the fluid system. In particular, the rotational movement facilitates alignment and connection of the additional openings 68 in the outer housing 16 which may be transverse to the other openings in the fitting.

In FIG. 7G, the inner conduit 14 is inserted in the outer conduit 18 to form the coaxial hose. The distal end 65 of the outer conduit 18 is engaged by the barbs 60 on the housing inner end portion 46 until the outer conduit 18 is fully seated against the shoulder 64 of the housing 16.

The outer conduit 18 can then be clamped or otherwise coupled to the outer housing 16 by a screw clamp 63 or other securing mechanism to complete the fitting as shown in FIG. 7H. Prior to securing the screw clamp 63, the outer housing 16 can be rotated relative to the inner body 12 and within the outer conduit 18. The outer housing 16 can therefore be placed in general alignment with the external components to which it will be attached prior to connection of the screw clamp 63.

Upon completion of the fitting at one end of the coaxial hose, a corresponding fitting can be assembled on the opposite end. As will be appreciated, the outer conduit 18 can be cut or trimmed to a desired length in the event that it is too long to fit into the fitting on the opposite end of the hose.

Once assembled, the fitting can then be installed into a fluid system by connecting the outer end portion 24 of the inner body 12 to an external component and the additional housing opening(s) 68 to an auxiliary hose or other element.

Fluid from the inner conduit 14 is directed through the passageway 32 to the outer end portion 23 of the inner body 12. A second fluid in the outer conduit 18 is directed through the hole 47 in the outer housing 16. The hole 47 is blocked by the inner body 12 and sealing element 70, such that the second fluid is directed through the additional opening(s) 68.

The rotation of the outer housing 16 relative to the inner body 12 enables the alignment and connection of the fitting to other components of the fluid system, especially when the additional openings 68 in the outer housing 16 are transverse to the other openings in the outer housing 16 and/or the openings in the inner body 12. The fitting 10 therefore provides an installer significant leeway in assembling the fitting and connecting it to the other components of the fluid system. The rotation of the housing can be performed without twisting the inner and outer conduits relative to one another, which can reduce twisting and/or kinking of the coaxial hose.

In the event that the coaxial hose or fitting needs to be inspected, serviced, repaired and/or replaced, the fitting described herein can be easily deconstructed, serviced and reused. By unsecuring the retaining element and removing the securing mechanism 63 from the outer conduit 18, the outer housing 16 can be removed from the coaxial hose and the inner body 12 can be slid axially out of the outer housing 16 through the housing inner end portion 44 (e.g., such that the inner end portion 22 of the inner body 12 is slid out of the outer housing 16 before the outer end portion 24 of the inner body 12). The components of the fitting and/or coaxial hose can be serviced or replaced as needed. The fitting can then be reconstructed as described above without damaging and/or destroying the fitting.

The fitting described herein can be used in a system for delivering two fluids separately from one another to a common fitting. For example, in a painting system it maybe necessary to heat paint in the hose as it is delivered from the reservoir or paint supply to an applicator, such as a paint sprayer. Using a coaxial hose assembly, the paint can be supplied to the applicator through the inner conduit and a heated fluid can be supplied through the outer conduit. The heated fluid surrounds the inner conduit and therefore maintains the temperature of the paint at a desired level. The fitting can be used to deliver the paint to the applicator through the inner body and to recirculate the heated fluid through the additional openings in the outer housing.

For applications in which non-rotation of the housing is desired, the fitting can be modified by adding features such as modifying the hole through the outer housing for square, hex or other features, and incorporating those same features into the inner body. Additionally or alternatively, key slots can be incorporated in both the outer housing and the inner body or threads can be added to the inner body and a lock nut or compression nut and sleeve can used to connect the outer housing to the inner body.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A termination fitting for an assembly comprising an inner fluid conduit for a first fluid received coaxially in an outer fluid conduit for a second fluid, each of the inner and the outer fluid conduits terminating at a distal end disposable generally coterminous with the distal end of the other fluid conduit, the fitting comprising:
an body extending along a longitudinal body axis intermediate a body first end and a body second end, the body having a first passageway therethrough for a first fluid, the first passageway extending along the body axis intermediate a first opening at the body first end and a second opening at the body second end, the body first end being configured as an inner connector for a distal end of an inner fluid conduit;
a housing extending along a longitudinal housing axis intermediate a housing first end and a housing second end, the housing being received coaxially over the body and having a second passageway therethrough for the second fluid, the second passageway extending along the housing axis intermediate a first opening at the housing first end and a second opening at the housing second end, the housing having a third opening into the second passageway between the housing first and second ends, and the housing first end being configured as an outer connector for a distal end of an outer fluid conduit; and
a seal disposed between the housing and the body intermediate the housing second and third openings, the seal closing the housing second opening such that the second fluid flows through the second passageway between the housing first and third openings.

2. The termination fitting of claim 1 wherein the housing third opening is disposed generally transverse to the housing second opening.

3. The termination fitting of claim 1 wherein the housing second end is attached to the body.

4. The termination fitting of claim 1 in combination with a coaxial hose assembly comprising an inner fluid conduit for a first fluid received coaxially in an outer fluid conduit for a second fluid, each of the inner and the outer fluid conduit terminating at a distal end disposable generally coterminous with the distal end of the other fluid conduit,
the body first end being connected to the distal end of the inner fluid conduit and the housing first end being connected to the distal end of the outer fluid conduit.

5. The assembly of claim 4, wherein:
the inner and the outer fluid conduit each is, independently, a length of hose or tubing; and
the housing first end and the body first end each is configured, independently, as a hose or tubing connector for connection to the distal end of the corresponding fluid conduit.

6. The assembly of claim 5 wherein the third opening of the housing is disposed generally transverse to the housing second opening.

7. The assembly of claim 5 wherein the second end of the housing is attached to the body.

8. A method of assembling a fitting to a coaxial hose assembly comprising:
attaching an inner body to an inner hose, the inner body having a through passage for communicating with an interior portion of the inner hose;
telescopically moving an outer housing over the inner body from an outer end portion of the body towards an inner end portion of the body;
positioning an axially inner end portion of the outer body coextensively with an outer hose which, together with the inner hose, forms a coaxial hose; and
restricting axial movement of the outer housing relative to the inner body.

9. The method of claim 8, wherein restricting axial movement of the outer housing relative to the inner body includes threading the outer housing onto the inner body.

10. The method of claim 8, wherein the restricting axial movement comprises attaching a retaining element to the inner body to trap a portion of the outer housing between the retaining element and a radially outwardly extending abutment on the inner body.

11. The method of claim 8, further comprising receiving a first fluid from the inner conduit through the body and receiving a second fluid from the outer conduit through the housing.

12. The method of claim 9, further comprising sealing the body to the housing with a sealing member.

13. A coaxial hose fitting comprising:
an inner body including an outer end portion configured for connection to an external component, an inner end portion configured for connection to an inner conduit of a coaxial hose, and an axially extending passage through the inner body from the outer end portion to the inner end portion;
an outer housing including an inner end portion configured for connection to an outer conduit of the coaxial hose and an axially extending hole through the outer housing from the inner end portion of the outer housing to an outer end portion of the outer housing, the hole being sized such that the outer housing can be telescopically moved over the inner body from the outer end portion of the inner body toward the inner end portion of the inner body; and
a retaining element for restricting axial movement of the outer housing relative to the inner body after the outer housing has been telescopically moved over the inner body.

14. The coaxial hose fitting of claim 13, wherein the retaining element is a threaded engagement between a portion of the inner body intermediate the inner and the outer end portions of the inner body, and an inner annular wall of the outer housing.

15. The coaxial hose fitting of claim 13, wherein the inner body includes a radially outwardly extending abutment and the retaining element restricts axial movement of the outer housing relative to the inner body by trapping a portion of the outer housing between the retaining element and the radially outwardly extending abutment of the inner body.

16. The coaxial hose fitting of claim 13, wherein the retaining element includes an annular ring.

20. The coaxial hose fitting of claim 13, wherein the retaining element is removably connected to the inner body.

18. The coaxial hose fitting of claim 13, further comprising an annular seal for sealing between the outer housing and the inner body.

19. The coaxial hose fitting of claim 13, further comprising a transverse opening in the outer housing that is in fluid communication with the hole through the outer housing.
